(19) United States
(12) Patent Application Publication
(10) Pub. No.: US 2021/0244200 A1
(43) Pub. Date: Aug. 12, 2021

(54) ACCESSORY MOUNTING COLLET FOR A MONITOR ARM SUPPORT POST

(71) Applicants: Roger Landon Webb, Chiswick (GB); Antonio Jose Fernandes da Costa, Northwood (GB); Brent Ralph Marchant, Mesa, AZ (US); Alex Joseph Frank, Tempe, AZ (US); Travis Jordan Rogers, Gilbert, AZ (US); Christopher Michael Morrow, Queen Creek, AZ (US); Cristoval Adrian Gutierrez, Mesa, AZ (US); Tai Hoon K. Matlin, Round Lake Beach, IL (US)

(72) Inventors: Roger Landon Webb, Chiswick (GB); Antonio Jose Fernandes da Costa, Northwood (GB); Brent Ralph Marchant, Mesa, AZ (US); Alex Joseph Frank, Tempe, AZ (US); Travis Jordan Rogers, Gilbert, AZ (US); Christopher Michael Morrow, Queen Creek, AZ (US); Cristoval Adrian Gutierrez, Mesa, AZ (US); Tai Hoon K. Matlin, Round Lake Beach, IL (US)

(21) Appl. No.: 17/170,380

(22) Filed: Feb. 8, 2021

Related U.S. Application Data
(60) Provisional application No. 62/971,731, filed on Feb. 7, 2020.

(51) Int. Cl. A47F 5/06; F16B 12/10

(52) U.S. Cl. CPC A47F 5/06; F16B 12/10

(57) ABSTRACT

A structure or apparatus for attaching accessories or monitor arms to the post of an monitor or display stand. The apparatus included a collar or collet for selectively attaching to a post of the stand, the collet or collar includes a plurality of slots or keyways or receivers about its circumference, the collar or collet including a retainer to selectively allow access to the slots to allow accessories to the placed in the slots or secured in the slots. The plurality of slots allows the accessories to be placed in different orientations or positions with respect to one another. The accessories have profile portions that are complimentary to the receivers.

### BACKGROUND OF THE INVENTION

### Field of the Invention

The invention relates to monitor stands and arms for supporting displays and monitors in and office environment.

### Background Art

Monitor arms have become a familiar structure in office environments and are used to support, position, and adjust computer displays. A single monitor arm unit may have multiple support posts, each support post having multiple arms extending therefrom. Monitor arms of the prior art have attached the arms to a vertical post by having a member with an aperture surround the post. This arrangement usually requires the member be placed into position by sliding the member aperture over the top of the post. This placement makes removal cumbersome if other arms are also placed on the post at a position above the first member.

In other prior art embodiments, multiple arms are attached to the member having the aperture. In such arrangements, member is a short bar having generally vertical portions placed 180 degrees apart about the aperture. Monitor arms may then be attached to each portion. This placement allows the arms to counter balance each other. While the position of the bar may be moved up and down the post, and rotated about the post, the mounting position of the monitor arms on the bar are always 180 degrees apart. Thus moving the bar affects both monitor arms attached to the bar.

### SUMMARY OF THE INVENTION

The invention is a support that permits selective attachment of a plurality of accessories onto a central mounting post. In the most typical embodiment, the invention is a collet that mounts about or around a central vertical post or support of a monitor arm. The collet may include a set screw to allow its vertical position to be fixed to the post.

In other embodiments the collet may take the form of a clamp with a provision to allow the circumference of the central aperture of the collet to be adjusted to place a clamping force on the post. In such an embodiment the collet includes a break, gap, or opening in the aperture sidewall, and flanges on either side of the break. An adjustable fastener may be coupled to the flanges to selectively close or reduce the break, thereby reducing the circumference and tightening the central aperture of the collet.

A function of the collet is to provide a means or structure to selectively attach support arms and other accessories to the vertical post. The collet thereby acts as a hub from which accessories or other members or structures may be attached or mounted. In some embodiments, the collet includes slots or keyways about its perimeter which are adapted to receive flanges, keys, or other complementary structures to couple, connect, join, or otherwise secure accessories to the collet, and thereby to the vertical support post or column. With such an arrangement of slots or keyways, accessories may be attached to the collet at select intervals about the collet. This allows for placement of accessories at any location 360 degrees around the vertical post. For instance, two monitor arms may be attached at positions 180 degrees apart, and an additional accessory such as a phone holder may be attached to the collet at a position between the attachment of the monitor arms. One will recognize that multiple accessories may be attached to the collet at any given time.

The accessories that may be attached include lighting, pen holders, file holders, phone holders, laptop holders, tablet holders, phone holders, changing holders, privacy panels, tool holders, docking stations, power stations, wire management devices, and other desktop or office accessories.

The collet keyways or slots may be of any configuration that allows selectively attaching or detaching the accessory from the collet. In some embodiments, the slots are tapered. The taper of the slots may be front to back, as well as top to bottom. The taper allows the accessory mating portion of the accessory to have a tighter fit as the accessory mating portion is placed and secured in the slot.

In some embodiments of the inventions, the slots may be described as dovetails in profile. The accessories would have a corresponding dovetail shape to fit into such a dovetail slot.

In some embodiments, the collet includes a plurality of t-shaped radially spaced receivers for receiving accessories.

In some embodiments of the invention, the accessory and the collet are coupled or connected by any means or structure used to selectively connect structures. It is preferable that the collet and accessory have structures that are complementary in profile to allow the accessory to be selectively placed and secured on the collet.

In some embodiments, such as those requiring extra support for an accessory, the accessory mating portion may include more than one profile and couple with more than one complementary profile on the collet. For instance a heavier accessory such as a monitor arm may be coupled to two slots of the collet. One will also recognize that the slots that connect such an accessory need not be adjacent to one another.

In some embodiments of the invention, multiple collets are attached to the same post.

In other embodiments, the features of the collet can be incorporated directly into or onto the structure of the post, including the walls of the post.

In one form, the invention is directed to an apparatus for attaching accessories to a post of a display support. The apparatus includes a collet. The collet has a plurality of slots about its outer circumference. The collet has a central aperture for placing about the post. The slots have a profile. The apparatus includes at least one accessory. The accessory includes an accessory profile portion that is complimentary to the profile of one of the plurality of slots.

In one form, the slots are open at the top and closed at the bottom.

In one form, the slots are tapered.

In one form, the slots include a void between an outer wall of the collet and in interior wall of the collet.

In one form, the collet includes a retainer selectively coupled to the collet to selectively obstruct the top of the slots.

In one form, the retainer is a ring.

In one form, the at least one accessory includes a bearing surface in contact with the outer wall of the collet.

In one form, the at least one accessory profile portion is in a slot. A filler occupies the remaining plurality of slots.

In one form the term collet is also used to describe a collar.

In one form, the invention is directed to an apparatus for attaching accessories to a post of a display support. The apparatus includes a collet having an interior wall and an exterior wall. A plurality of webs connect the interior wall to the exterior wall. The exterior wall has a plurality of openings. A plurality of receiving voids between the interior wall and exterior wall are in communication with the plurality of openings.

In one form, the plurality of openings are open at the top of collet and closed towards the bottom of the collet.

In one form, the plurality of openings are wider at a top of the openings and narrower at a bottom of the openings.

In one form, the plurality of voids are wider at a top of the voids than at a bottom of the voids.

In one form the interior wall is closer to the exterior wall towards the bottom of the collet than towards the top of the collet.

In one form, the collet includes a retainer for selectively closing the top of the plurality of openings.

In one form, the retainer is selectively coupled to the collet.

In one form, the accessory includes a profile portion. The profile portion has a bearing surface in contact with the exterior wall of the collet.

In one form, the profile portion and the bearing surface capture a portion of the collet exterior wall.

In one form, the accessory includes a profile portion having a rib sized to fit in the opening. The rib has a flange. A bearing surface is adjacent the rib. The bearing surface and flange capture the exterior wall.

In one form, the accessory has a first profile portion and a second profile portion. The first profile portion engages a first opening and the second profile portion engages a second opening.

In one form, the invention is directed to an apparatus for attaching accessories to a post of a display support. The apparatus includes a collet having an interior wall and an exterior wall. A plurality of webs connect the interior wall to the exterior wall. The exterior wall has a plurality of slots open at the top of the exterior wall. A plurality of receiving voids between the interior wall and exterior wall are in communication with the plurality of slots. The receiving voids receive profile portions of accessories.

In one form, the profile portion of an accessory includes a flange and a bearing surface for capturing a portion of the exterior wall of the collet therebetween. The collet further includes a retainer for selectively closing to slots at the top of the exterior wall.

### BRIEF DESCRIPTION OF THE DRAWINGS

FIG. 1 is a view of two collets of the present invention on a post with accessories attached to the collets.

FIG. 2 is a view of two collets of the present invention on a post with articulating monitor arms attached to the collets to present three displays in alignment.

FIG. 3 is an elevational view of a collet of the present invention on a post with an articulating monitor arm.

FIG. 4 is an exploded view of FIG. 3.

FIG. 5 is an exploded view of a collet of the present invention and two articulating monitor arms.

FIG. 6 is a perspective view of a collet including inserts on a post.

FIG. 7 is a perspective view of a collet including inserts with one insert removed.

FIG. 8 is a top perspective view showing a collet and accessory arm detached, showing how keyways of the collet and profiles of the accessory arm are complementary.

FIG. 9 is a perspective view showing the collet on a post with two accessory arms attached to the collet 180 degrees apart.

FIG. 10 is a perspective view showing the collet on a post with two accessory arms attached to the collet less than 180 degrees apart with only one empty keyway between the arms.

FIG. 11 is a top perspective view showing a lock ring on the collet mounted on a post,

FIG. 12 is a keyway insert or filler having a profile.

FIG. 13 is a top perspective view of a collet on a post showing two empty keyways or slots.

FIG. 14 is a perspective view of a portion of an accessory arm having two profiles and bearing surfaces.

FIG. 15 is a cross-sectional view of a collet and attached accessory arm having two profiles.

FIG. 16 is a cross-sectional view of a collet and detached accessory arm having two profiles.

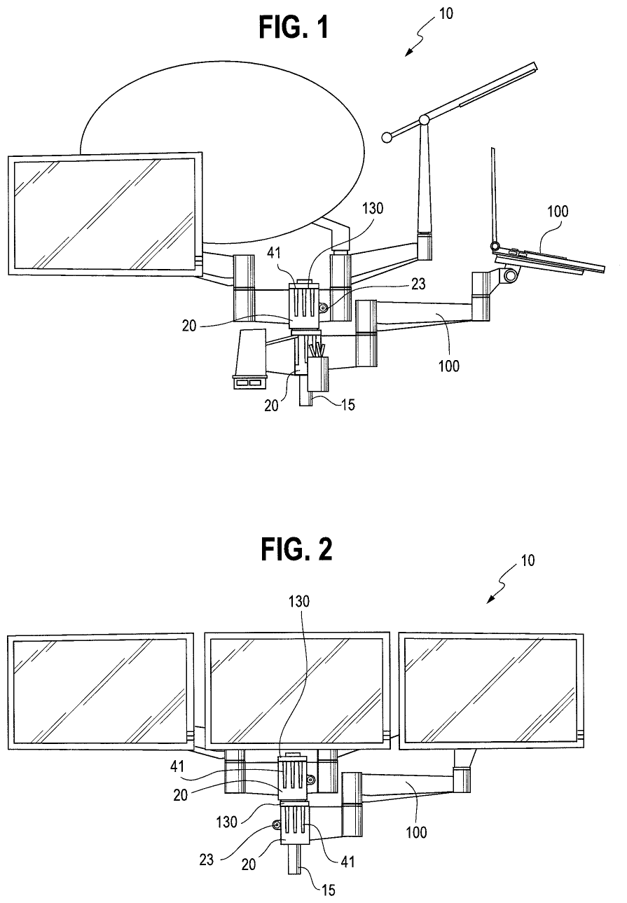

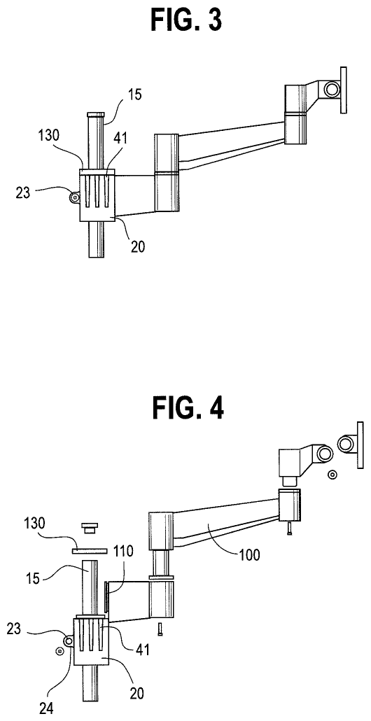

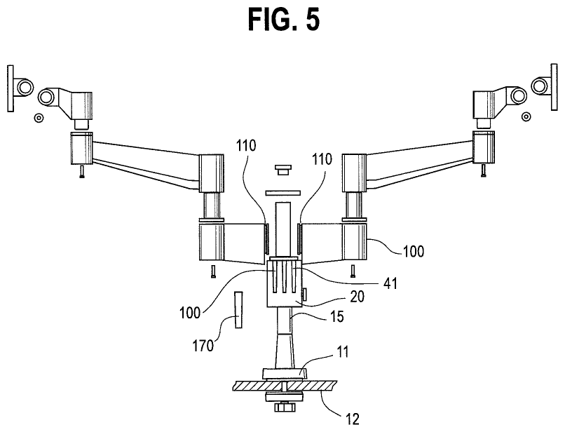

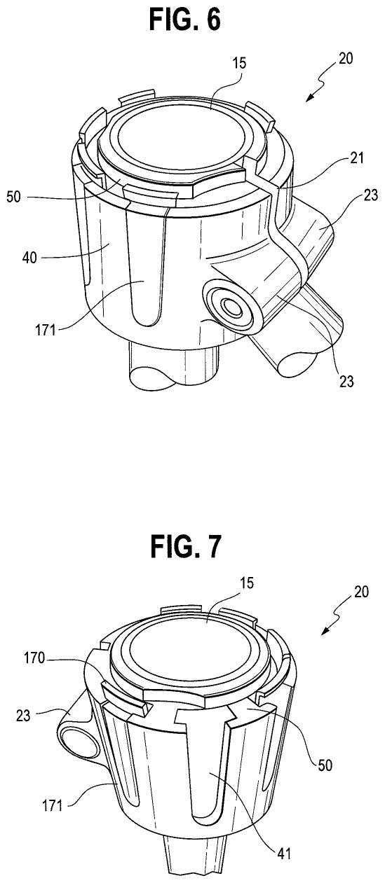

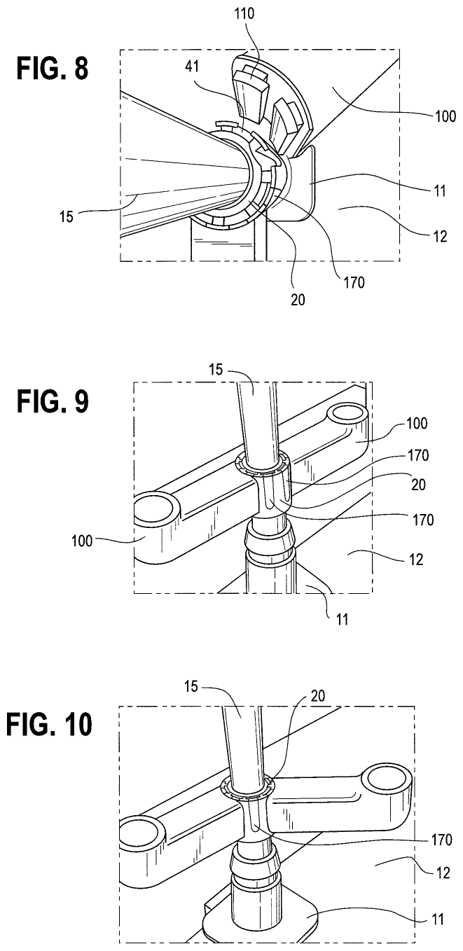

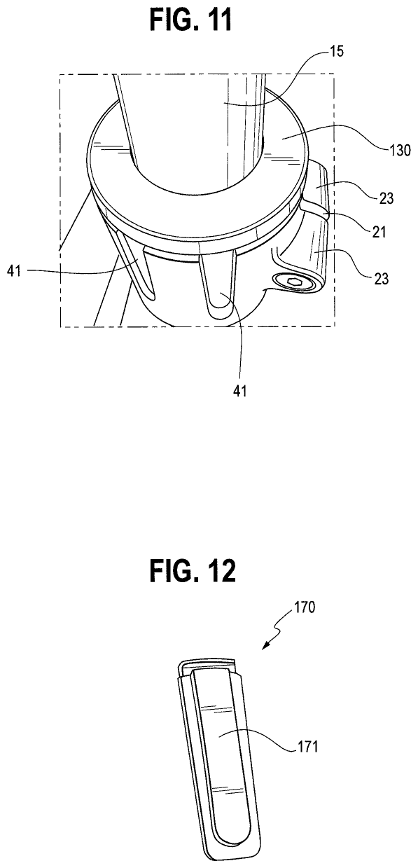

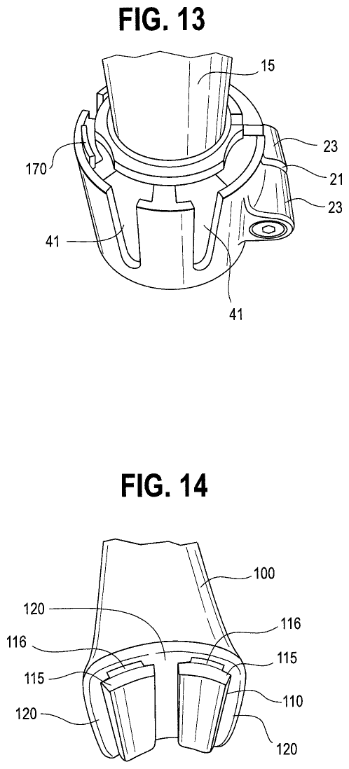

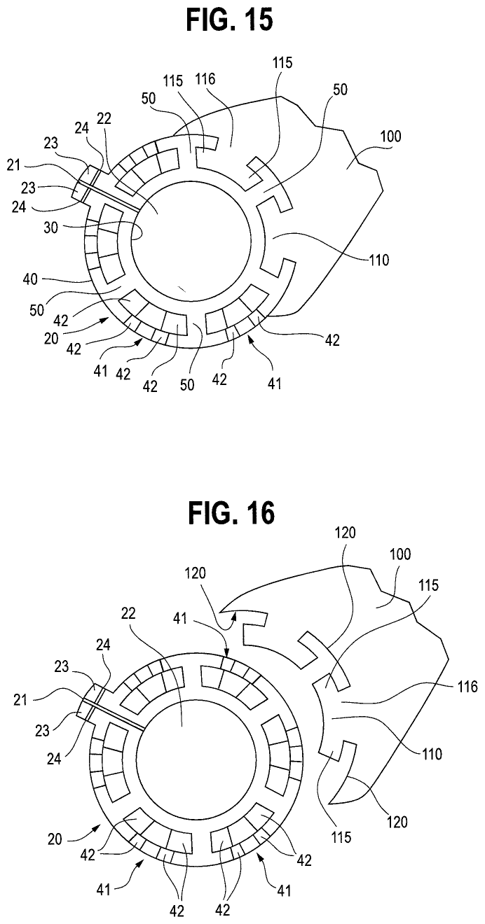

### DETAILED DESCRIPTION OF THE PREFERRED EMBODIMENT

With reference to the figures, the display support assembly 10 for use with the invention includes a base 11 for attaching to a support surface 12. Coupled to the base 11 is a vertical support or post 15 that extends upward from the base 11.

In some embodiments, the post 15 is a tubular structure with a circular cross-section, and having walls or a singular continuous wall defining the post's 15 perimeter. The walls may have any thickness and may incorporate the slots, keyways, or other complementary attaching structures discussed for the collet 20 discussed herein. The post 15 may be of any cross section.

In some embodiments, the collet 20 is placed around or about the wall of the post 15. The collet may include a break 21 to allow for selectively clamping the collet 20 about the post 15. The cross section of the interior or aperture 22 of the collet may be similar to the cross section of the post 15. The collet 20 need not include the ability to clamp or tighten to grip the post 15 in some embodiments.

In some embodiments, the collet 20 includes an interior wall 30 that may be in contact with the wall of the post 15 when the collet is clamped or otherwise secured on the post 15. The collet 20 may also include a set screw through the interior wall 30 for securing the collet 20 in place on the post 15.

In some embodiments, the collet 20 includes an outer wall 40. The outer wall 40 may include a plurality of slots 41, openings, or keyways for accepting or receiving accessories 100. The outer wall 40 and interior wall 30 may be connected by webs 50. It is preferred that the webs 50 extend from the top of the collet 20 outer wall 40 to the bottom of the otter wall 40. In other embodiments, the webs 50 do not extend from top to bottom. In other embodiments, the webs are intermittently placed between the top and bottom of the outer wall. In other embodiments, the webs 50 may have a portion or portions that extend above or below the outer wall 40.

In some embodiments, the collet 20 includes flanges 23, the flanges placed on opposite sides of the break 21. The flanges include apertures 24. An adjustable lock pin or bolt is placed in the apertures to selectively tighten or loosen the clamping aspect of the collet by drawing the flanges 23 closer together or farther apart. The clamping and unclamping of the collet 20 allowing the position of the collet 20 on the post 15 to be adjusted both up and down, as well as rotationally about the post 15.

In some embodiments, the slots 41 are tapered, having an opening at the top of the outer wall 40 that is wider than the width of the distal end of the slot. The slots 41 may also not be tapered.

In some embodiments, a slot 41 includes an opening at the top of the outer wall 40 to accept a portion of an accessory 100. The opening allows the accessory 100 to be placed into the slot 41 from above and moving the accessory 100 downward with respect to the collet 20, thus allowing gravity to assist in retaining the accessory to the collet 20. The slot 41 has side walls 42 which narrow, which restrict movement of the accessory 100 as the sidewalls 42 pinch the portion of the accessory 100 that is in the slot 41. In some embodiments the slot includes a bottom wall 43 defining the bottom of the slot. In other embodiments, the slot 41 does not have a bottom wall.

In some embodiments, the slot 41 may include a void or receiving area or receiver between the outer wall 40 and interior wall 30. In some embodiments the void is also defined by the webs 50 connecting the interior wall 30 to the outer wall 40. The outer wall 40 portions adjacent the slots 41 act to retain accessories 100 to the collet by receiving profile portions 110 of the accessories 100.

In some embodiments, the accessories 100 such as monitor arms include a profile portion 110. The profile portion 110 may include a profile or other structure that is complimentary to a slot 41 and the void behind the slot such that the slot 41 and void may receive and retain the profile portion 110 of the accessory 100. It is preferred that the profile portion 110 include surfaces that contact both the interior wall 30 and the outer wall 40 surfaces that define the void. This contact limits unwanted movement of the accessory 100.

As shown by non-limiting examples in the figures, the profile portion may include flanges 115 on either side of a rib 116. The rib 116 is tapered to be wider at the top than at the distal end, thus being complementary in shape to the slot 41. The flanges 115 are curved or arcuate to fit in and be received by the void between the interior wall 30 and the outer wall 40. In the most preferred embodiment, the flanges 115 include surfaces that contact both the interior wall 30 and surfaces that contact the outer wall 40 to better secure or couple the accessory 100 to the collet 20.

In some embodiments, the accessory 100 includes a bearing surface 120 adjacent or near the rib 116. The bearing surface 120 may be on both sides of the rib 116, thus creating a plurality of bearing surfaces 120. The bearing surface is in contact with the outer wall 40 of the collet 20. Thus the outer wall 40 of the collet 20 is captured between the profile portion 110 and the bearing surface 120. More particularly in the non-limiting example, the outer wall 40 is captured between the flanges 115 of the profile and the bearing surface 120.

The accessory 110 may be further secured, coupled, or captured to the collet. In some embodiments, the assembly includes a retaining ring 130. The retaining ring 130 is coupled to the top of the collet 20. In some embodiments, the retaining ring 130 is coupled to the top of the collet 20 by a bayonet mount, and may be selectively placed on or removed from the collet 20 by rotating the retaining ring 130 with respect to the collet 20. When in place, the retaining ring covers or obstructs the top or openings in the slots 41, preventing or limiting the upward movement of the coupled accessories 100. One skilled in the art will recognize that the retaining ring 120 may be positioned at the bottom of the collet 20 if the slots 41 open to the bottom of the collet 20 rather than the top.

In other embodiments, the retaining ring 130 may be selectively coupled or secured to the collet 20 by a releasable locking tab. In other embodiments, the retaining ring 130 and the collet 20 may be selectively coupled by removable fasteners such as screws or bolts and nuts. In other embodiments, the retaining ring 130 and collet may be selectively coupled by complementary threads.

In some embodiments, a slot may be occupied by a filler 170. The filler 170 includes an outer surface 171 that is flush with the outer wall 40 of the collet 20. In some embodiments, the filler 170 stands proud from the outer wall 40. In some embodiments, the filler 170 includes indicia on the outer surface. The filler 170 may include a profile to retain the filler in the slot 41. One will recognize that the filler 170 may not need a profile as robust as the profile for a heavier accessory such as a monitor arm.

The accessories for use with the assembly may vary, and multiple different accessories may be attached to the collet 20 at the same time. Accessories may include monitor arms, monitor supports, shelves, sup holders, power outlets, phone stands, tablet stands, file holders, book holders, magnets, storage units, or other office desk accessories. Such accessories may include a single profile portion 110 or a plurality of profile portions 110 to allow for attachment to the collet 20.

The foregoing disclosure of specific embodiments is intended to be illustrative of the broad concepts comprehended by the invention.

1. An apparatus for attaching accessories to a post of a display support, the apparatus including a collet, the collet including a plurality of slots about its outer circumference, the collet including a central aperture for placing about the post, the slots having a profile, and at least one accessory, the accessory including an accessory profile portion that is complimentary to the profile of one of the plurality of slots.

2. The apparatus of claim 1, wherein the slots are open at the top, and closed at the bottom.

3. The apparatus of claim 1 wherein the slots are tapered.

4. The apparatus of claim 1, wherein the slots include a void between an outer wall of the collet and in interior wall of the collet.

5. The apparatus of claim 2, wherein the collet includes a retainer selectively coupled to the collet to selectively obstruct the top of the slots.

6. The apparatus of claim 5, wherein the retainer is a ring.

7. The apparatus of claim 4 wherein the at least one accessory includes a bearing surface in contact with the outer wall of the collet.

8. The apparatus of claim 1, wherein the at least one accessory profile portion is in a slot and a filler occupies the remaining plurality of slots.

9. An apparatus for attaching accessories to a post of a display support, the apparatus including a collet having an interior wall and an exterior wall, a plurality of webs connecting the interior wall to the exterior wall, the exterior wall including a plurality of openings, a plurality of receiving voids between the interior wall and exterior wall in communication with the plurality of openings.

10. The apparatus of claim 9 wherein the plurality of openings are open at the top of collet and closed towards the bottom of the collet.

11. The apparatus of claim 9 wherein the plurality of openings are wider at a top of the openings and narrower at a bottom of the openings.

12. The apparatus of claim 9 wherein the plurality of voids are wider at a top of the voids than at a bottom of the voids.

13. The apparatus of claim 10 wherein the collet includes a retainer for selectively closing the top of the plurality of openings.

14. The apparatus of claim 13, wherein the retainer is selectively coupled to the collet.

15. The apparatus of claim 9, the accessory including a profile portion, the profile portion including a bearing surface in contact with the exterior wall of the collet.

16. The apparatus of claim 15, wherein the profile portion and the bearing surface capture a portion of the collet exterior wall.

17. The apparatus of claim 9, the accessory including a profile portion having a rib sized to fit in the opening, the rib having a flange, a bearing surface adjacent the rib, the bearing surface and flange capturing the exterior wall.

18. The apparatus of claim 17, wherein the accessory includes a first profile portion and a second profile portion, the first profile portion engaging a first opening and the second profile portion engaging a second opening.

19. An apparatus for attaching accessories to a post of a display support, the apparatus including a collet having an interior wall and an exterior wall, a plurality of webs connecting the interior wall to the exterior wall, the exterior wall including a plurality of slots open at the top of the exterior wall, a plurality of receiving voids between the interior wall and exterior wall in communication with the plurality of slots, the receiving voids for receiving profile portions of accessories.

20. The apparatus of claim 19, wherein the profile portion of an accessory includes a flange and a bearing surface for capturing a portion of the exterior wall of the collet therebetween, the collet further including a retainer for selectively closing to slots at the top of the exterior wall.
